(19) United States
(12) Patent Application Publication
(10) Pub. No.: US 2024/0095497 A1
(43) Pub. Date: Mar. 21, 2024

(54) USING A TUNABLE PRE-TRAINED DISCRIMINATOR TO TRAIN A GENERATOR AND AN UNTRAINED DISCRIMINATOR

(71) Applicant: Capital One Services, LLC, McLean, VA (US)

(72) Inventors: Austin Walters, Savoy, IL (US); Galen Rafferty, Mahomet, IL (US); Jeremy Goodsitt, Champaign, IL (US); Anh Truong, Champaign, IL (US)

(21) Appl. No.: 17/947,778

(22) Filed: Sep. 19, 2022

(51) Int. Cl. G06N 3/04; G06N 3/08

(52) U.S. Cl. CPC G06N 3/0454; G06N 3/08

(57) ABSTRACT

Systems as described herein may implement a tunable pre-trained discriminator in a machine learning model, such as a general adversarial network. A server may generate training data using a generator of the machine learning model. The server may send the training data to a first discriminator (e.g., a pre-trained discriminator) and a second discriminator (e.g., an untrained discriminator). The server may receive a first set and a second set of labels from the first discriminator and the second discriminator, respectively. The server may select a label from either the first or the second set of labels. Accordingly, the server may provide the selected labels and the corresponding data records to further train the generator of the machine learning model.

### FIELD OF USE

Aspects of the disclosure relate generally to big data and more specifically to the processing of big data using machine learning models.

### BACKGROUND

An enterprise may implement various proprietary machine learning models to process big data. A machine learning model, such as a generative adversarial network (GAN), may include a generator and a discriminator. However, the GAN may become unstable in the training process such that the discriminator may stop learning and provide no feedback to the generator. As a result, the performance of the machine learning models may suffer. This may limit the enterprise's ability to use machine learning models to provide predictions, insights, and/or forecasts.

Aspects described herein may address these and other problems, and generally improve the performance, accuracy, and efficiency of processing big data using machine learning models.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below. Corresponding apparatus, systems, and computer-readable media are also within the scope of the disclosure.

Systems as described herein may include features for implementing a tunable, pre-trained discriminator in a machine learning model, such as a GAN. A tunable machine learning system may generate, by a generator of the machine learning model, a plurality of data records as training data to train one or more discriminators. The system may send the plurality of data records to a first discriminator and a second discriminator. The first discriminator may include a pre-trained discriminator and the second discriminator may include an untrained discriminator. The system may receive a first set of labels corresponding to the plurality of data records from the first discriminator. The system may receive a second set of labels corresponding to the plurality of data records from the second discriminator. The system may determine an accuracy for each of the first set of labels and an accuracy for each of the second set of labels. The system may select a label for each of the plurality of data records from either the first set of labels or the second set of labels based on a determination of which has a higher degree of accuracy for the particular data record. Accordingly, the system may provide the plurality of data records and the selected labels as input to the generator to further train the machine learning model. This improved technique for generating the machine learning model allows the training of both the generator and the second (untrained) discriminator to converge in real-time, thereby creating an optimized GAN model.

These features, along with many others, are discussed in greater detail below.

### BRIEF DESCRIPTION OF THE DRAWINGS

The present disclosure is described by way of example and not limited in the accompanying figures in which like reference numerals indicate similar elements and in which:

FIG. 1 depicts an example of a computing device that may be used in implementing one or more aspects of the disclosure in accordance with one or more illustrative aspects discussed herein;

FIG. 2 depicts an example of deep neural network architecture for a model according to one or more aspects of the disclosure;

FIG. 3 depicts a tunable system comprising different computing devices that may be used in implementing one or more aspects of the disclosure in accordance with one or more illustrative aspects discussed herein;

FIG. 4 depicts example of a machine learning model according to one or more aspects of the disclosure; and

FIG. 5 shows a flow chart of a process for implementing tunable pre-trained discriminator according to one or more aspects of the disclosure.

### DETAILED DESCRIPTION

In the following description of the various embodiments, reference is made to the accompanying drawings, which form a part hereof, and in which is shown by way of various illustrative embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. In addition, it is to be understood that the phraseology and terminology used herein are for the purpose of description and should not be regarded as limiting. Rather, the phrases and terms used herein are to be given their broadest interpretation and meaning.

By way of introduction, aspects discussed herein may relate to methods and techniques for implementing a tunable, pre-trained discriminator in a machine learning model, such as a GAN. A tunable machine learning system may include a generator of the machine learning model and use the generator to generate training data to train one or more discriminators. The training data may include real data, synthetic data generated by the generator, or both as seeds. The system may send the training data to a first discriminator and a second discriminator. The first discriminator may include a pre-trained discriminator and the second discriminator may include an untrained discriminator. The system may receive a first set of labels from the first discriminator and a second set of labels from the second discriminator. The system may determine an accuracy for each of the first set of labels and an accuracy for each of the second set of labels, and select a label from either the first set of labels or the second set of labels, based on which has a higher degree of accuracy. Accordingly, the system may provide the selected label and the corresponding data record as input to the generator to train the machine learning model.

In many aspects, the tunable system may provide second training data to pre-train the first discriminator. For example, the first discriminator may be pre-trained using a second plurality of data records and a label for each record of the second plurality data records. The tunable system may pre-train the first discriminator prior to sending the training data to the first discriminator and the second discriminator. The tunable system may train the second discriminator (e.g., the untrained discriminator) until a prediction accuracy of the second discriminator surpasses a prediction accuracy of the first discriminator (e.g., the pre-trained discriminator). After training the generator and the second discriminator, the tunable system may generate a new machine learning model that comprises the generator and the second discriminator.

In many aspects, the tunable system may use the selected label and the corresponding data record as input to further train the generator. The tunable system may select, for the each of the plurality of data records, the label from either the first set of labels or the second set of labels. The tunable system may determine the accuracy for each of the first set of labels and the second set of labels using a loss function. The loss function may indicate the performance of a prediction model (e.g., the discriminator) and compute the distance between the current output of the prediction model and the expected output. For example, based on a determination that a loss function associated with the second set of labels is above a threshold value, the tunable system may select the label from the first set of labels. Conversely, based on a determination that a loss function associated with the second set of labels is below a threshold value, the tunable system may select the label from the second set of labels. Additionally and alternatively, the tunable system may use a machine learning model to determine a selection of the label from the first set of labels and the second set of labels.

In many aspects, the tunable system may use the output from the generator to further train the discriminators in the next iteration. The tunable system may receive improved training data as output from the generator of the machine learning model. The tunable system may send the improved training data to the first discriminator and the second discriminator. The tunable system may receive a third set of labels corresponding to the improved training data from the first discriminator and a fourth set of labels corresponding to the improved training data form the second discriminator. Based on a determination that a confidence level associated with the fourth set of labels is above a threshold value, the tunable system may select, for the each of the plurality of data records, the label from the fourth set of labels. The tunable system may provide the selected fourth set of labels as the input to the generator of the machine learning model to generate new improved training data.

Aspects described herein improve the functioning of computers, and in particular improve the accuracy and performance of machine learning models. This is a problem specific to computer-implemented processes, and the processes described herein could not be performed in the human mind (and/or, e.g., with pen and paper). For example, as will be described in further detail below, the processes described herein rely on the processing of big data including transaction data, and the use of various machine learning models.

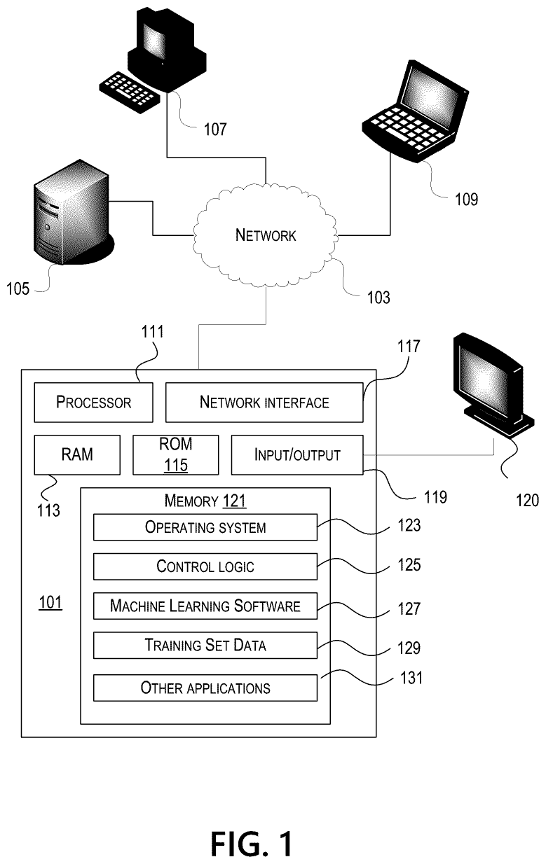

Before discussing these concepts in greater detail, however, several examples of a computing device that may be used in implementing and/or otherwise providing various aspects of the disclosure will first be discussed with respect to FIG. 1.

FIG. 1 illustrates one example of a computing device 101 that may be used to implement one or more illustrative aspects discussed herein. For example, computing device 101 may, in some embodiments, implement one or more aspects of the disclosure by reading and/or executing instructions and performing one or more actions based on the instructions. In some embodiments, computing device 101 may represent, be incorporated in, and/or include various devices such as a desktop computer, a computer server, a mobile device (e.g., a laptop computer, a tablet computer, a smart phone, any other types of mobile computing devices, and the like), and/or any other type of data processing device.

Computing device 101 may, in some embodiments, operate in a standalone environment. In others, computing device 101 may operate in a networked environment. As shown in FIG. 1, computing devices 101, 105, 107, and 109 may be interconnected via a network 103, such as the Internet. Other networks may also or alternatively be used, including private intranets, corporate networks, LANs, wireless networks, personal networks (PAN), and the like. Network 103 is for illustration purposes and may be replaced with fewer or additional computer networks. A local area network (LAN) may have one or more of any known LAN topology and may use one or more of a variety of different protocols, such as Ethernet. Computing devices 101, 105, 107, 109 and other devices (not shown) may be connected to one or more of the networks via twisted pair wires, coaxial cable, fiber optics, radio waves or other communication media.

As seen in FIG. 1, computing device 101 may include a processor 111, RAM 113, ROM 115, network interface 117, input/output interfaces (I/O) 119 (e.g., keyboard, mouse, display, printer, etc.), and memory 121. Processor 111 may include one or more computer processing units (CPUs), graphical processing units (GPUs), and/or other processing units such as a processor adapted to perform computations associated with machine learning. I/O 119 may include a variety of interface units and/or drivers for reading, writing, displaying, and/or printing data or files. I/O 119 may be coupled with a display such as display 120. Memory 121 may store software for configuring computing device 101 into a special purpose computing device in order to perform one or more of the various functions discussed herein. Memory 121 may store operating system software 123 for controlling overall operation of computing device 101, control logic 125 for instructing computing device 101 to perform aspects discussed herein, machine learning software 127, training set data 129, and/or other applications 131. Control logic 125 may be incorporated in and may be a part of machine learning software 127. In other embodiments, computing device 101 may include two or more of any and/or all of these components (e.g., two or more processors, two or more memories, etc.) and/or other components and/or subsystems not illustrated here.

Computing devices 105, 107, 109 may have similar or different architecture as described with respect to computing device 101. Those of skill in the art will appreciate that the functionality of computing device 101 (or device 105, 107, 109) as described herein may be spread across multiple data processing devices, for example, to distribute processing load across multiple computers, to segregate transactions based on geographic location, user access level, quality of service (QoS), etc. For example, computing devices 101, 105, 107, 109, and others may operate in concert to provide parallel computing features in support of the operation of control logic 125 and/or machine learning software 127.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) Perl, Python, or any equivalent thereof. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product.

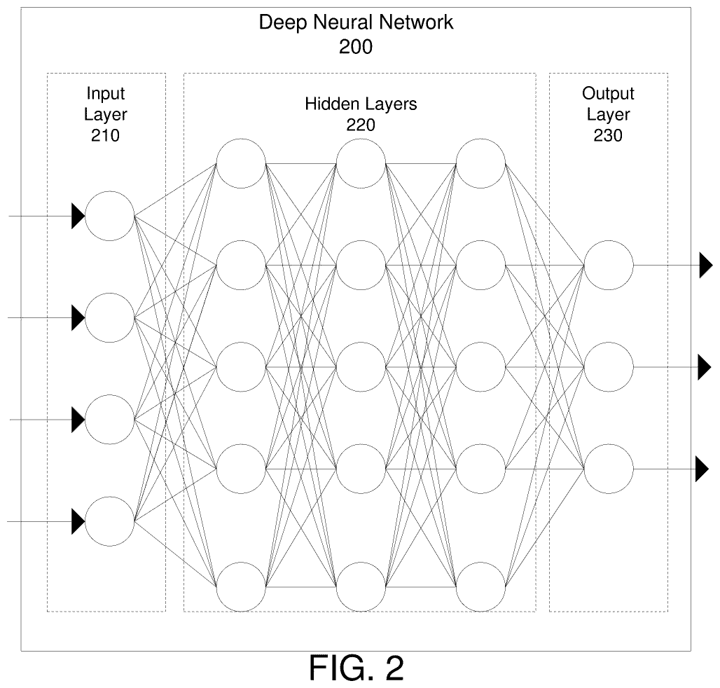

FIG. 2 illustrates an example of deep neural network architecture 200. Such a deep neural network architecture may constitute all or portions of the machine learning software 127 shown in FIG. 1. That said, the architecture depicted in FIG. 2 need not be performed on a single computing device, and might be performed by, e.g., a plurality of computers (e.g., one or more of the computing devices 101, 105, 107, 109). An artificial neural network may be a collection of connected nodes, with the nodes and connections each having assigned weights used to generate predictions. Each node in the artificial neural network may receive input and generate an output signal. The output of a node in the artificial neural network may be a function of its inputs and the weights associated with the edges. Ultimately, the trained model may be provided with input beyond the training set and used to generate predictions regarding the likely results. Artificial neural networks may have many applications, including object classification, image recognition, speech recognition, natural language processing, text recognition, regression analysis, behavior modeling, and/or others.

An artificial neural network may have an input layer 210, one or more hidden layers 220, and an output layer 230. A deep neural network, as used herein, may be an artificial network that has more than one hidden layer (e.g., hidden layers 220). Illustrated deep neural network architecture 200 is depicted with three hidden layers (e.g., indicated by the three columns of nodes), and thus may be considered a deep neural network. The number of hidden layers employed in deep neural network architecture 200 may vary based on the particular application and/or problem domain. For example, a network model used for image recognition may have a different number of hidden layers than a network used for speech recognition. Similarly, the number of input and/or output nodes may vary based on the application. Many types of deep neural networks are used in practice, such as convolutional neural networks, recurrent neural networks, feed forward neural networks, combinations thereof, and others.

During the model training process, the weights of each connection and/or node may be adjusted in a learning process as the model adapts to generate more accurate predictions on a training set. The weights assigned to each connection and/or node may be referred to as the model parameters. The model may be initialized with a random or white noise set of initial model parameters. The model parameters may then be iteratively adjusted using, for example, stochastic gradient descent algorithms that seek to minimize errors in the model.

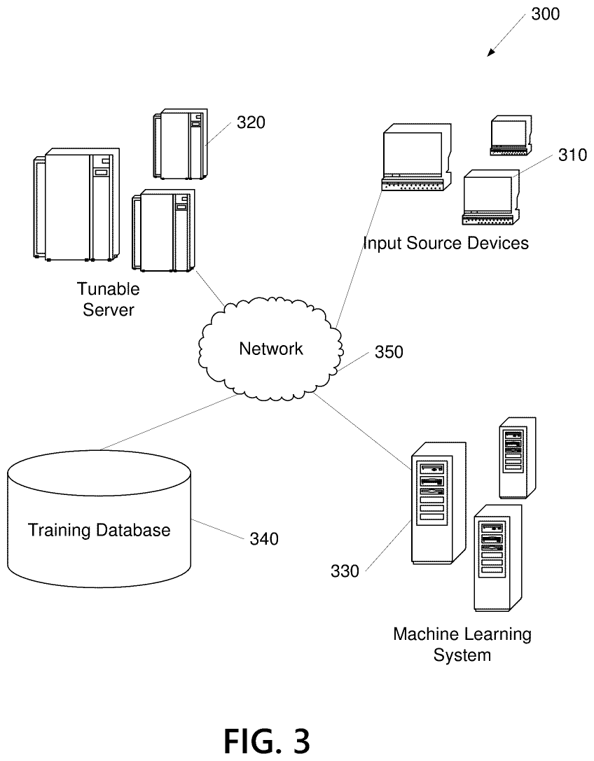

FIG. 3 shows a tunable system 300. The tunable system 300 may include at least one input source device 310, at least one tunable server 320, one or more machine learning systems 330, and/or at least one training database 340 all interconnected via a network 350. It will be appreciated that the network connections shown are illustrative and any means of establishing a communications link between the computers may be used. The existence of any of various network protocols such as TCP/IP, Ethernet, FTP, HTTP and the like, and of various wireless communication technologies such as GSM, CDMA, WiFi, and LTE, is presumed, and the various computing devices described herein may be configured to communicate using any of these network protocols or technologies. Any of the devices and systems described herein may be implemented, in whole or in part, using one or more computing systems described with respect to FIG. 1.

Input source device 310 may be any device capable of obtaining data records that contain a collection of text, some of which may represent transaction data. For example, the collection of text may be related to a transaction record containing confidential financial data, such as an account identifier, the transaction time, transaction amount, and/or a merchant name. The collection of text may be related to comments or feedback of a service provided by a financial institution or other service provider that may be potentially harmful (e.g., financially, economically, reputationally, etc.) if it were to be divulged to a third-party. The collection of text may include personnel information, such as performance reviews that may be sensitive or confidential. The collection of text may also be related to documents reviewed during a litigation process that may be confidential or privileged and may not be disclosed to a third-party. Input source devices 310 may include scanner, a camera, camera-arrays, camera-enabled mobile-devices, etc. Alternatively, input source devices 310 may include computing devices, such as laptop computers, desktop computers, mobile devices, smart phones, tablets, and the like. According to some examples, input source devices 310 may include hardware and software that allow them to connect directly to network 350. Alternatively, input source devices 310 may connect to a local device, such as a personal computer, server, or other computing device, which connects to network 350. In some embodiments, input source devices 310 may include a scanner associated with an automated teller machine (ATM). The scanner may be configured to scan checks, certificates of deposit, money orders, and/or currency. In other embodiments, the input source devices 310 may be a scanner located at a branch location. The scanner may be configured to scan documents, such as loan and/or credit applications, and securely transmit the documents to a central location, such as a head office or a central banking location, for further processing.

Tunable server 320 may collect, parse, and/or store documents containing data records. The documents may be stored as unstructured data from various sources, including, for example, books, journals, metadata, health records, audio, video, analog data, images, files, and/or unstructured text, such as the body of an e-mail message, Web page, or word-processor document. For example, tunable server 320 may extract content and/or data from a content website automatically using a bot or web scraper. Tunable server 320 may access the content website using a web protocol, such as Hypertext Transfer Protocol (HTTP), or through a web browser. Tunable server 320 may obtain a data dump from the content sources and store the data in a corpus database (not shown in FIG. 3). The corpus database may also be part of training database 340. Tunable server 320 may copy and/or collect unstructured data in a text format from the web and convert the data into a common format, such as a JavaScript Object Notation (JSON) format, a comma-separated values (CSV) format, or an Extensible Markup Language (XML) format. Tunable server 320 may store the documents containing confidential data in the corpus database for later retrieval or analysis.

Tunable server 320 may retrieve the documents containing the data records from the corpus database or receive the documents from input source devices 310. Tunable server 320 may parse collections of text in the documents to identify keywords and/or confidential data. Tunable server 120 may filter certain stop words from the text, such as “that,” “the,” “are,” “to” and the like, to adjust for the fact that some words may appear more frequently, but carry less weight. Tunable server 320 may filter the stop words using, for example, term frequency—inverse document frequency (TFIDF), which may be a numerical statistic model that may reflect how important a word is to a document in a collection or corpus.

Tunable server 320 may convert a document containing the data records into text embeddings based on a collection of text in the document. Tunable server 320 may subsequently input the text embeddings to machine learning systems 330. Machine learning systems 330 may be on a computing system separate from tunable server 320. Alternatively, machine learning systems 330 may be a component of tunable server 320 (not shown in FIG. 3). Machine learning systems 330 may include one or more machine learning models. The one or more machine learning models may comprise proprietary machine learning models. The one or more machine learning models may be traditional machine learning models such as a decision tree model, a standard normal variate (SNV) model, a support vector machine (SVM) model or a random forest model. Machine learning system 330 may include one or more neural network machine learning models. The one or more neural network machine learning models may implement the deep neural network architecture 200 illustrated in FIG. 2. The one or more neural network machine learning models may include, for example, a fully connected neural network (FCNN), a convolutional neural network (CNN), a recurrent neural network, or a feed forward neural network. Machine learning systems 330 may include an autoencoder, a variational autoencoder (VAE), a Bidirectional Encoder Representations from Transforms (BERT) Model, or a transformer model.

Tunable server 320 may improve the accuracy and performance of an existing traditional machine learning model or an existing neural network machine learning model. For example, tunable server 320 may switch a traditional machine learning model to a neural network machine learning model to boost the performance gained from the architecture and standardization of the neural network machine learning model. Tunable server 320 may train an existing neural network machine learning model using a pre-trained discriminator (e.g., a first discriminator) and an untrained discriminator (e.g., a second discriminator) in the machine learning model. Tunable server 320 may pre-train the first discriminator using training data from training database 340. The training data may include real data or synthetic data with predetermined labels.

Tunable server 320 may allow the untrained discriminator to be trained using the pre-trained discriminator as a proxy. For example, tunable server 320 may use the generator in the GAN model to generate data records as training data. The training data may be fed to the first and second discriminators. For the same data record in the training data, the first discriminator may generate a first label and the second discriminator may generate a second label. Tunable server 320 may compare accuracies of the first label and second label to determine whether the labels correctly identify the data record. For example, the tunable server 320 may compare the accuracies of the labels using a loss function. If the loss function is high, which may indicate that there is a great discrepancy between the first and second labels, the tunable server 320 may select the first label and the corresponding data record as input to the generator. Otherwise, the tunable server 320 may select the second label and the corresponding data record as input to the generator. As such, the generator may be trained based on selected labels generated by either the first discriminator or the second discriminator.

Tunable server 320 may run numerous iterations of the training process with the generator and the first and second discriminators. As the training process progresses, the second discriminator may outperform the first discriminator. For example, the loss function may be stabilized and the second discriminator may generate labels with a higher confidence level than that of the first discriminator. Such results may be verified by human data labelers to determine whether the labels produced by the second discriminator outperform the first discriminator. When the second discriminator outperforms the first discriminator, the labels generated by the second discriminator may be fed as input to the generator, and the generator may continue to generate synthetic data to train the second discriminator. The generator and the second discriminator may be trained until a confidence level reaches a threshold value. Accordingly, the training of the generator and the second discriminator may converge to form a new neural network machine learning model (e.g., the generator and the second discriminator) to replace the existing machine learning model (e.g., the generator and the first discriminator).

Training database 340 may store documents (e.g., confidential data) and their corresponding labels. For example, training database 340 may store transaction records related to transactions previously conducted by users in transaction streams from customers of an organization. The transaction records may each contain an account identifier, a transaction amount, a transaction time, and/or a merchant identifier. A transaction record may be stored with a label, such as class 1 or class 0, where class 1 may correspond to fraudulent transactions and class 0 may correspond to non-fraudulent transactions. In another example, training database 340 may store comments or feedback from customers related to a service provided by an organization or other service providers. For example, a record in training database 340 may include a record identifier, a customer identifier, a comment field related to feedback on a service provided, and/or a label such as a negative or positive to indicate the nature of the customer experience with the service. Training database 340 may also store image files, such as images that may be classified as dogs and cats.

Tunable server 320 may later retrieve the labeled documents containing confidential data and send the labeled documents to a computing device (not shown) to provide insights to the confidential data to facilitate tasks related to, for example, credit decisioning process and fraud detection logic. For example, the computing device may be a server in a financial institution that processes loan and/or credit applications. Based on the label indicating the related transaction being fraudulent or non-fraudulent, the computing device may approve or deny the applications.

Input source devices 310, tunable server 320, machine learning systems 330, and/or training database 340 may be associated with a particular authentication session. Tunable server 320 may receive, process, and store a variety of data records and other confidential information, and/or receive data records from input source devices 310 as described herein. However, it should be noted that any device in tunable system 300 may perform any of the processes and/or store any data as described herein. Some or all of the data described herein may be stored using one or more databases. Databases may include, but are not limited to relational databases, hierarchical databases, distributed databases, in-memory databases, flat file databases, XML databases, NoSQL databases, graph databases, and/or a combination thereof. The network 350 may include a local area network (LAN), a wide area network (WAN), a wireless telecommunications network, and/or any other communication network or combination thereof.

The data transferred to and from various computing devices in tunable system 300 may include secure and sensitive data, such as confidential documents, customer personally identifiable information, and account data. Therefore, it may be desirable to protect transmissions of such data using secure network protocols and encryption, and/or to protect the integrity of the data when stored on the various computing devices. A file-based integration scheme or a service-based integration scheme may be utilized for transmitting data between the various computing devices. Data may be transmitted using various network communication protocols. Secure data transmission protocols and/or encryption may be used in file transfers to protect the integrity of the data such as, but not limited to, File Transfer Protocol (FTP), Secure File Transfer Protocol (SFTP), and/or Pretty Good Privacy (PGP) encryption. In many embodiments, one or more web services may be implemented within the various computing devices. Web services may be accessed by authorized external devices and users to support input, extraction, and manipulation of data between the various computing devices in tunable system 300. Web services built to support a personalized display system may be cross-domain and/or cross-platform, and may be built for enterprise use. Data may be transmitted using the Secure Sockets Layer (SSL) or Transport Layer Security (TLS) protocol to provide secure connections between the computing devices. Web services may be implemented using the WS-Security standard, providing for secure SOAP messages using XML encryption. Specialized hardware may be used to provide secure web services. Secure network appliances may include built-in features such as hardware-accelerated SSL and HTTPS, WS-Security, and/or firewalls. Such specialized hardware may be installed and configured in tunable system 300 in front of one or more computing devices such that any external devices may communicate directly with the specialized hardware.

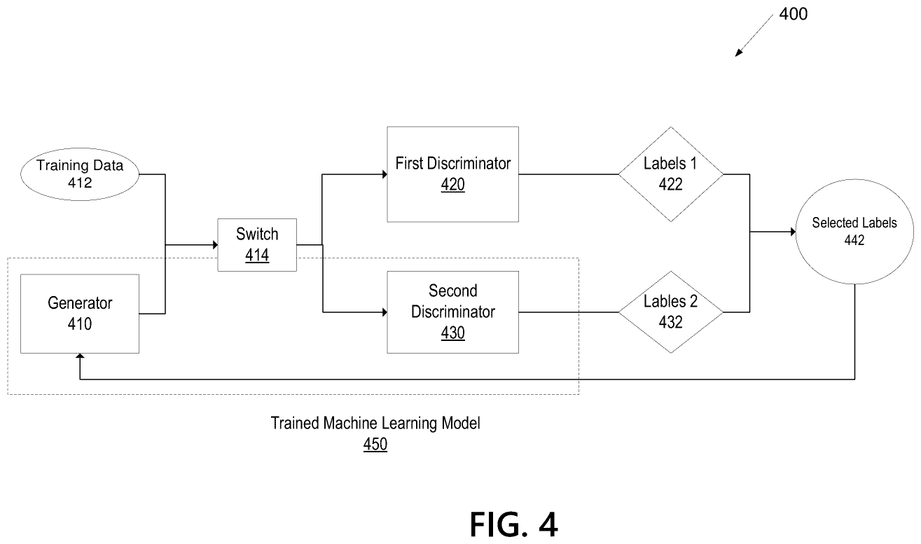

FIG. 4 depicts an example of a machine learning model according to one or more aspects of the disclosure. As illustrated in FIG. 4, system 400 may include a generator 410, a first discriminator 420, and a second discriminator 430. First discriminator 420 may be a pre-trained discriminator and second discriminator 430 may be an untrained discriminator. In some examples, the first discriminator 420 may correspond to a component in a machine learning model, which may be a proprietary machine learning model developed by an organization suitable for processing big data within the organization. The first discriminator 420 may also be a component of a traditional machine learning model, such as a decision tree model, an SNV model, an SVM model, or a random forest model. In some examples, the proprietary or traditional machine learning model may include the generator 410 and the first discriminator 420, which may constitute a neural network machine learning model with the deep neural network architecture 200 illustrated in FIG. 2. The proprietary machine learning models may also include an autoencoder, a VAE, a BERT Model, or a transformer model.

A tunable server (not shown in FIG. 4) may provide training data 412 comprising data records to train the first discriminator 420 and/or second discriminator 430. For example, the training data 412 may include real data, such as ground-truth images, transaction data related to fraudulent and non-fraudulent transactions, or customer feedback information including confidential data. The training data 412 may also include synthetic data generated by generator 410 or other generators that may stored in a training database, such as training database 340. For example, the training data 412 may include synthetic images of dogs and cats generated by the generator 410. The training data 412 may include synthetic transaction data including fraudulent or non-fraudulent transactions. The first discriminator 420 may be pre-trained by the training data 412 retrieved from the training database (e.g., training database 340). An optional switch 414 may control how much of the training data 412 may be transmitted to the first discriminator 420 and the second discriminator 430, respectively. For example, a first set of the training data 412 may be transmitted to the first discriminator 420 and a second set of the training data 412 may be transmitted to the second discriminator 430. In the first iterations of the training process, the amount of first set of training data 412 may be larger than that of the second set of training data 412, given that the first discriminator 420 is pre-trained and the second discriminator 430 is untrained. As the training process progresses along, the switch 414 may increase the amount of the training data 412 transmitted to the second discriminator 430 in subsequent iterations.

In some examples, the switch 414 may be optional and the same training data 412 may be transmitted to both the first discriminator 420 and the second discriminator 430. First discriminator 420 may generate a first set of labels 422 for the training data 412, and second discriminator 430 may generate a second set labels 432 for the training data 412. The tunable server may select a label for a data record in the training data 412 from either the first set of labels 422 or the second set of labels 432, based on a determination of which has a higher degree of accuracy. The selected label 442 and the corresponding data record may be provided as input to the generator 410 to generate new synthetic data to train the first discriminator 420 and the second discriminator 430 in the next iteration of training.

In a first plurality of iterations, a first label, from the first set of labels 422, may have a higher degree of accuracy than a second label, from the second set of labels 432, given that the first discriminator 420 is pre-trained and may make better predictions than the second discriminator 430. As the training process progresses along, the second discriminator 430 may be trained and may have a degree of accuracy equal to or surpassing that of the first discriminator 420. In this fashion, the generator 410, the first discriminator 420, and the second discriminator 430 may be trained in parallel in real time, and the generator 410 and the second discriminator 430 may improve and converge continuously. As such, the tunable server may generate a trained or improved machine learning model including the generator 410 and the second discriminator 430. The trained machine learning model may have enhanced performance compared to that of the existing machine learning model comprising the first discriminator 420.

As noted above, an organization may acquire data records, sensitive data and/or confidential information about users via documents, forms, etc. Machine learning models may be used to analyze those documents to identify the data and/or information contained in these documents, forms, etc. Additionally or alternatively, machine learning models may be used to identify the context (e.g., positive or negative, fraudulent or non-fraudulent, good or bad, etc.). The tunable system described herein may enhance the performance of traditional machine learning models. For example, traditional machine learning models may process data records and generate the corresponding predicted labels for the data records. The tunable system may implement an improved machine learning model which may be trained based on the traditional machine learning models. The tunable system may use a pre-trained discriminator as a proxy to train an untrained discriminator so that the untrained discriminator may surpass the performance of the pre-trained discriminator. The trained or improved machine learning model may process the data records to make more accurate and sophisticated predictions.

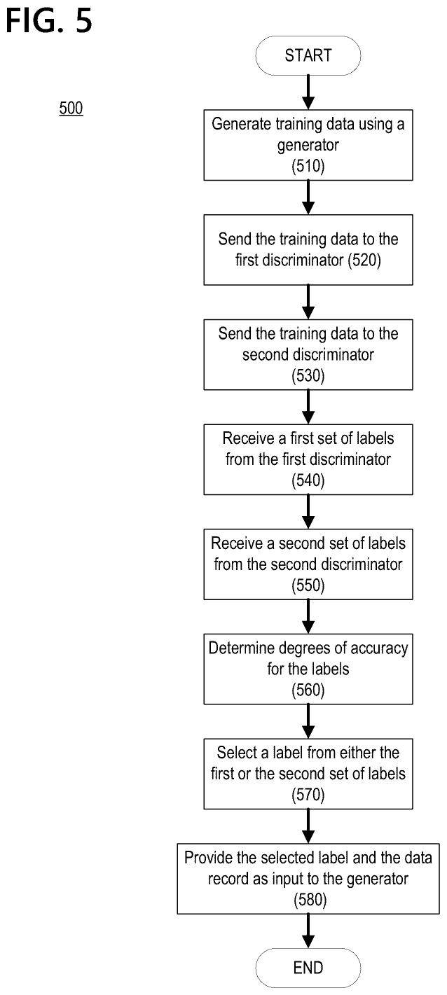

FIG. 5 shows a flow chart of a process 500 for implementing tunable pre-trained discriminator according to one or more aspects of the disclosure. Some or all of the steps of process 500 may be performed using one or more computing devices as described herein.

At step 510, a server (e.g., tunable server 320) may generate a plurality of data records as training data to train one or more discriminators in a machine learning model, such as a GAN model. The training data may be generated by a generator of the machine learning model. The training data may also include real data such as certain transaction records retrieved from a training database. The tunable server may also receive data records comprising a collection of text from various input devices in real time. The data records may be in a first data format, and the collection of text may represent a plurality of confidential data. For example, the tunable server may receive transaction records related to previously conducted transactions that may be labeled either as fraudulent or non-fraudulent. The transaction records may provide insights to facilitate credit decisioning and/or fraud detection logic. The transaction records may include confidential information, such as an account identifier, a transaction amount, a transaction time, transaction location, a channel of transaction (e.g., online or in physical store), and/or a merchant identifier. In a variety of embodiments, the documents may be collected in an unstructured data format, such as text format and converted into a common format, such as a JSON format, CSV format, or an XML format.

The documents may be collected and processed in a data stream in real time. The collected documents may be processed in a batch process. For example, the documents containing confidential data may be collected periodically or the documents may be dumped at predetermined intervals (e.g., periodically), such as once per 10 minutes, once per hour, or once per day. Confidential data in the text format may be pre-processed via a random sampling to eliminate duplicated data. Confidential data may be dumped after a verification of non-duplicated data to produce a light weight data payload.

The tunable server may pre-process the data records using natural language processing (NLP) or optical character recognition (OCR) to parse the documents and/or identify keywords. The tunable server may remove certain stop words that do not add much meaning to the sentences, such as “and,” “at,” “the,” “is,” “which,” etc.

The server may provide certain pre-processed data records to the generator of the machine learning model to generate synthetic data. For example, the pre-process data records may represent real transaction records with predefined labels (e.g., fraudulent or non-fraudulent). The generator may generate synthetic transaction records based on real transaction records, for example, by replacing a transaction amount, a transaction time, or a transaction location in a real transaction record. In some examples, the server may provide to the generator ground-truth images of, for example, images of dogs and cats to be labeled with appropriate labels. The generator may generate synthetic images of dogs and cats based on the ground-truth images. The training data may include the synthetic data generated by the generator. The training data may include real data such as real transaction records with labels or ground-truth images with labels. The training data may also include a mix of the synthetic data and the real data and the mix percentage may be a variable adjusted by the server.

At step 520, the server may send the training data including the plurality of data records to a first discriminator. At step 530, the server may send the training data including the plurality of data records to a second discriminator. The server may send the training data including a first percentage of real data to the first discriminator and the server may send the training data including a second percentage of real data to the second discriminator. The first percentage and the second percentage may be the same or may be different. The first discriminator may include a pre-trained discriminator, while the second discriminator may include an untrained discriminator. In some examples, the first discriminator may correspond to a component in an existing machine learning model in the organization. The existing machine learning model may use data values recorded in the data records, for example, a transaction amount, to make predictions and generate predicted labels. The server may pre-train the first discriminator using training data in real time or historic training data. The existing machine learning model may be a proprietary machine learning model developed by the organization to process big data (e.g., transaction data) related to the business of the organization (e.g., a financial institution). The existing machine learning model may be a traditional machine learning model such as a decision tree machine learning model, which uses a decision tree as a predictive model, where the leaves represent class labels and branches represent conjunctions of features that lead to the class labels. However, the decision tree machine learning model may suffer performance issues in certain circumstances. For example, a small change in the training data may result in a drastic change in the tree and the final prediction. The decision tree learners may create overly-complex trees that do not generalize well from the training data. In some examples, the existing machine learning model may include a neural network machine learning model. For example, the generator and the first discriminator may correspond to an existing neural network machine learning model. The existing neural network machine learning models may, for example, suffer from instability issues in the training process, where the model may reach a point that the first discriminator may stop learning and provide minimal feedback to the generator. As a result, the performance of the existing machine learning models may be less optimal. The server may train a machine learning model including the generator and the untrained second discriminator to improve the performance of the existing machine learning models.

The server may implement a switch mechanism to determine a first set of the training data for the first discriminator and the second set of the training data for the second discriminator. The switch may control the learning speed of the generator. The switch may send a majority of the training data to the first discriminator in the initial iterations of the training cycles. For example, the switch may initially send 80% of the training data to the first discriminator and 20% of the training data to the second discriminator. The server may also use a machine learning model to determine how much training data to send to the first and second discriminators, respectively. The switch may increase the amount of training data sent to the second discriminator in subsequent training cycles. At the end of the training cycles, the switch may send all, or a majority, of the training data to the second discriminator.

The server may not use the switch and may, instead, send the same training data to the first and second discriminators, simultaneously. For example, the training data may have ten training data samples and the same training data samples may be sent to the first discriminator and the second discriminator.

At step 540, the server may receive, from the first discriminator, a first set of labels corresponding to the data records in the training data. At step 550, the server may receive, from the second discriminator, a second set of labels corresponding to the data records in the training data. For example, the training data may have ten training data samples. The first discriminator may label the first five samples having 0 label (e.g., non-fraudulent) and the last five samples having 1 label (e.g., fraudulent). The second discriminator may label the first eight samples having 1 label (e.g., fraudulent) and the last 2 samples have 0 label (e.g., non-fraudulent).

At step 560, the server may determine an accuracy for each of the first set of labels and an accuracy for each of the second set of labels. The accuracy may be determined, for example, using a loss function. The loss function may represent a measurement of the performance a prediction model (e.g., the discriminator) that may compute the distance between the current output of the prediction model and the expected output. A high loss function may indicate a poor performance of the prediction model. The prediction model may optimize the algorithm to minimize the loss function.

At step 570, the server may select a label from either the first set of labels or the second set of labels, for example, based on a determination of which has a higher degree of accuracy for a data record. For example, in the ten training data samples, the first data record may be labeled as 0 by the first discriminator with a first degree of accuracy, and the first data record may be labeled as 1 by the second discriminator with a second degree of accuracy. The server may determine that the first degree of accuracy is higher than the second degree of accuracy. The server may select the label 0 output by the first discriminator. The server may also compare the loss function indicating the degree of accuracy in the first and second discriminators. For example, in the ten training data samples, the first data record may be labeled as 0 by the first discriminator with a first loss function, and the first data record may be labeled as 1 by the second discriminator with a second loss function. The server may determine that the first loss function is smaller than the second loss function, indicating the first discriminator having a higher degree of accuracy than that of the second discriminator. The server may select the label 0 output by the first discriminator. The server may further determine which label to select based on the loss function associated with the second discriminator and a threshold value. For example, in the ten training data samples, the first data record may be labeled as 0 by the first discriminator, and the first data record may be labeled as 1 by the second discriminator. If the server determines that a loss function associated with the second discriminator is above the threshold value, indicating the performance of the second discriminator may be less optimal, the server may select the label 0 output by the first discriminator. Otherwise, if the server determines that a loss function associated with the second discriminator is below the threshold value, indicating the performance of the second discriminator may be improved, the server may select the label 1 output by the second discriminator.

In some examples, the server may use a machine learning model to determine a selection of the label for the first data record. For example, the machine learning model may be trained to determine the threshold value for a loss function associated with the second discriminator. If the loss function is above the threshold value, the label output by the first discriminator may be selected for the first data record. Otherwise, the label output by the second discriminator may be selected for the data record. In the example of ten training data samples, both the first and second discriminators label the sixth data record as 1. This label may be selected without the comparison of the degree of accuracy or the loss function associated with the first and second discriminators.

At step 580, the server may provide the plurality of data records and the selected labels for each data records as input to the generator of the GAN model. For example, the tunable server may provide the first data record and the corresponding label 0, the second data record and the corresponding label 0, the third data record and the corresponding label 0, the fourth data record and the corresponding label 0, the fifth data record and the corresponding label 0, the sixth data record and the corresponding label 1, and so on, as input to the generator to start the next iteration of the training process. Based on the data records with the selected labels, the generator may generate improved training data including a new set of synthetic data records. For example, the new synthetic data records may include synthetic transaction records that may be labeled as 1 (e.g., fraudulent) or 0 (e.g., non-fraudulent). The server may send the new set of synthetic data records to the first and second discriminators, and receive a third set of labels from the first discriminator and a fourth set of labels from the second discriminator, corresponding to the new set of synthetic data records. The server may select a label from either the third or the fourth set of labels, similar to step 570. The server may provide, as the input to the generator of the GAN model, the selected labels and the corresponding data records to generate new improved training data to start the next iteration of the training process. Through the iterations of training cycles, the server may reach a point that the second discriminator may outperform the first discriminator. For example, the second discriminator may be trained such that a prediction accuracy of the second discriminator surpasses a predication accuracy of the first discriminator and converges in accuracy with the generator. Additionally or alternatively, the second discriminator may be trained to have a confidence level above a threshold value, indicating that the second discriminator may outperform the first discriminator. The trained generator and the second discriminator may constitute a new neural network machine learning model (e.g., a new GAN model) that may have improved performance over the existing machine learning model. The new neural network machine learning model may have the deep neural network architecture 200 as illustrated in FIG. 2. The new neural network machine learning model may include, for example, a FCNN, a CNN, a recurrent neural network, or a feed forward neural network. The server may generate the new neural network machine learning model to work as a proxy or an approximation of the existing machine learning model. The new neural network machine learning model may improve the functionalities and performance of the existing machine learning model.

The server may allow users in an enterprise to continue to use the existing machine learning model, while the new neural network machine learning model may be trained. The server may use parallel pipelines to train the new neural network machine learning model in real time, and the new model may continuously to be trained and improved. In contrast with the conventional machine learning models, where the generator needs to be trained first using real data, and the discriminator needs to be trained subsequently. The server may train the second discriminator in real-time with the generator using minimal real data or a small amount of real data as seeds. The second discriminator may be trained using synthetic data using the first discriminator as a proxy. The functionality of the second discriminator may converge with that of the generator. The server may capture snapshots of the training iterations. Periodical review of the snapshots (e.g., by data labelers) may provide feedback to the training process and prevent overfit.

The server may use the new neural network machine learning model to generate data labels for new data records. For example, the new data records may have a first record including a first sentence in a comment from a customer regarding a service provided by an institution. The server may store a first label associated with the first sentence generated by the new neural network machine learning model in the first record. Likewise, the server may store a second record including a second sentence in the comment with the second label. The training database may accordingly store six records corresponding to each of the six sentences in the comment, with the first three records all having positive labels (e.g., class 1) and the next three records all having negative labels (e.g., class 0) generated by the new neural network machine learning model. As such, the mappings between the labels to the particular portions of the original document may be stored in the training database.

The stored documents and the corresponding labels may be later retrieved from the training database and used as inputs or training data to various machine learning models as needed. The tunable server may use the new neural network machine learning model to label data record in real time. The tunable server may send the labeled data record to a computing device, such as a server that conducts credit decisioning for loan or credit card applications or fraud detecting logic for trans action processing.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, and the like that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid-state memory, RAM, and the like. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a system, and/or a computer program product.

Although the present invention has been described in certain specific aspects, many additional modifications and variations would be apparent to those skilled in the art. In particular, any of the various processes described above may be performed in alternative sequences and/or in parallel (on different computing devices) in order to achieve similar results in a manner that is more appropriate to the requirements of a specific application. It is therefore to be understood that the present invention may be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A computer-implemented method comprising:
generating, by a generator of a generative adversarial network (GAN) model, a plurality of data records as training data to train one or more discriminators;
sending, to a first discriminator, the plurality of data records, wherein the first discriminator comprises a trained discriminator;
sending, to a second discriminator, the plurality of data records, wherein the second discriminator is an untrained discriminator;
receiving, from the first discriminator, a first set of labels corresponding to the plurality of data records;
receiving, from the second discriminator, a second set of labels corresponding to the plurality of data records;
determining an accuracy for each of the first set of labels and an accuracy for each of the second set of labels;
selecting, for each of the plurality of data records, a label from either the first set of labels or the second set of labels based on a determination of which has a higher degree of accuracy for a data record; and
providing, as input to the generator of the GAN model, the plurality of data records and the selected labels for each of the plurality of data records.

2. The computer-implemented method of claim 1, wherein the accuracy for each of the first set of labels and the accuracy for each of the second set of labels is determined using a loss function.

3. The computer-implemented method of claim 1, wherein the training data comprises the plurality of data records and a first set of real data records, and the method further comprising:
providing second training data to the first discriminator prior to sending the plurality of data records to the first discriminator and the second discriminator, wherein the second training data comprises a second set of real data records, a second plurality of data records and a label for each record of the plurality of second data records.

4. The computer-implemented method of claim 1, further comprising:
training the second discriminator until a prediction accuracy of the second discriminator surpasses a predication accuracy of the first discriminator.

5. The computer-implemented method of claim 4, further comprising:
after training the second discriminator, generating a new GAN model comprising the generator and the second discriminator.

6. The computer-implemented method of claim 1, wherein selecting, for the each of the plurality of data records, the label from either the first set of labels or the second set of labels comprises:
based on a determination that a loss function associated with the second set of labels is above a threshold value, selecting the label from the first set of labels.

7. The computer-implemented method of claim 1, wherein selecting, for the each of the plurality of data records, the label from either the first set of labels or the second set of labels comprises:
based on a determination that a loss function associated with the second set of labels is below a threshold value, selecting the label from the second set of labels.

8. The computer-implemented method of claim 1, wherein selecting, for the each of the plurality of data records, the label from either the first set of labels or the second set of labels comprises:
using a machine learning model to determine a selection of the label from the first set of labels and the second set of labels.

9. The computer-implemented method of claim 1, further comprising:
receiving, as output from the generator of the GAN model, improved training data;
sending, to the first discriminator, the improved training data;
sending, to the second discriminator, the improved training data;
receiving, from the first discriminator, a third set of labels corresponding to the improved training data;
receiving, from the second discriminator, a fourth set of labels corresponding to the improved training data;
based on a determination that a confidence level associated with the fourth set of labels is above a threshold value, selecting, for the each of the plurality of data records, the label from the fourth set of labels; and
providing, as the input to the generator of the GAN model, the selected label to generate new improved training data.

10. A computing device comprising:
one or more processors; and
memory storing instructions that, when executed by the one or more processors, cause the computing device to:
generate, by a generator of a generative adversarial network (GAN) model, a plurality of data records as training data to train one or more discriminators;
send, to a first discriminator, the plurality of data records, wherein the first discriminator comprises a trained discriminator;
send, to a second discriminator, the plurality of data records, wherein the second discriminator is an untrained discriminator;
receive, from the first discriminator, a first set of labels corresponding to the plurality of data records;
receive, from the second discriminator, a second set of labels corresponding to the plurality of data records;
determine an accuracy for each of the first set of labels and an accuracy for each of the second set of labels;
select, for each of the plurality of data records, a label from either the first set of labels or the second set of labels based on a determination of which has a higher degree of accuracy for a data record; and
provide, as input to the generator of the GAN model, the plurality of data records and the selected labels for each of the plurality of data records.

11. The computing device of claim 10, wherein the accuracy for each of the first set of labels and the accuracy for each of the second set of labels is determined using a data loss function.

12. The computing device of claim 10, wherein the training data comprises the plurality of data records and a first set of real data records, and wherein the instructions when executed cause the computing device to:
provide second training data to the first discriminator prior to sending the plurality of data records to the first discriminator and the second discriminator, wherein the second training data comprises a second set of real data records, a second plurality of data records and a label for each record of the plurality of second data records.

13. The computing device of claim 10, wherein the instructions when executed cause the computing device to:
train the second discriminator until a prediction accuracy of the second discriminator surpasses a predication accuracy of the first discriminator.

14. The computing device of claim 13, wherein the instructions when executed cause the computing device to:
after training the second discriminator, generate a new GAN model comprising the generator and the second discriminator.

15. The computing device of claim 10, wherein the instructions when executed cause the computing device to select, for the each of the plurality of data records, the label from either the first set of labels or the second set of labels by causing the computing device to:
based on a determination that a loss function associated with the second set of labels is above a threshold value, select the label from the first set of labels.

16. The computing device of claim 10, wherein the instructions when executed cause the computing device to select, for the each of the plurality of data records, the label from either the first set of labels or the second set of labels by causing the computing device to:
based on a determination that a loss function associated with the second set of labels is below a threshold value, select the label from the second set of labels.

17. The computing device of claim 10, wherein the instructions when executed cause the computing device to select, for the each of the plurality of data records, the label from either the first set of labels or the second set of labels by causing the computing device to:
use a machine learning model to determine a selection of the label from the first set of labels or the second set of labels.

18. One or more non-transitory media storing instructions that, when executed by one or more processors, cause the one or more processors to perform steps comprising:
generating, by a generator of a generative adversarial network (GAN) model, a plurality of data records as training data to train one or more discriminators;
sending, to a first discriminator, the plurality of data records, wherein the first discriminator comprises a trained discriminator;
sending, to a second discriminator, the plurality of data records, wherein the second discriminator is an untrained discriminator;
receiving, from the first discriminator, a first set of labels corresponding to the plurality of data records;
receiving, from the second discriminator, a second set of labels corresponding to the plurality of data records;
determining an accuracy for each of the first set of labels and an accuracy for each of the second set of labels;
selecting, for each of the plurality of data records, a label from either the first set of labels or the second set of labels based on a determination of which has a higher degree of accuracy for a data record; and
providing, as input to the generator of the GAN model, the plurality of data records and the selected labels for each of the plurality of data records.

19. The non-transitory media of claim 18, wherein the accuracy for each of the first set of labels and the accuracy for each of the second set of labels is determined using a data loss function.

20. The non-transitory media of claim 18, wherein the instructions, when executed by one or more processors, cause the one or more processors to perform steps comprising:
training the second discriminator until a prediction accuracy of the second discriminator surpasses a predication accuracy of the first discriminator; and
after training the second discriminator, generating a new GAN model comprising the generator and the second discriminator.
